(19) United States
(12) Patent Application Publication
(10) Pub. No.: US 2024/0012413 A1
(43) Pub. Date: Jan. 11, 2024

(54) REDUNDANT SAFETY SYSTEM AND METHOD USING A REDUNDANT SAFETY SYSTEM

(71) Applicant: SICK AG, Waldkirch (DE)

(72) Inventors: Mathias AMS, Waldkirch (DE); Stefan SCHWÖRER, Waldkirch (DE); Eduard MOSGALEWSKY, Waldkirch (DE); Jörg RÖWEKÄMPER, Waldkirch (DE); Santosh TAVANSHI, Waldkirch (DE)

(21) Appl. No.: 18/211,654

(22) Filed: Jun. 20, 2023

(30) Foreign Application Priority Data
Jul. 8, 2022 (DE) 102022117036.5

(51) Int. Cl. G05D 1/00; G05D 1/02

(52) U.S. Cl. CPC G05D 1/0077; G05D 1/0214; G05D 1/0248; G05D 1/0274

(57) ABSTRACT

A method using a redundant safety system and a redundant safety system for a mobile machine having at least one controller, having a first localization system for localizing a position of at least one safe point of interest, having a detection system for detecting a feature of the safe point of interest, wherein a position of the safe point of interest can be detected by means of the localization system and a feature of the safe point of interest can be detected by means of the detection system, with a safe zone of interest associated with the safe point of interest being able to be activated by means of the controller on detection of the position of the safe point of interest and of the feature of the safe point of interest.

The present invention relates to a redundant safety system and to a method using a redundant safety system.

The invention deals with the safe localization of mobile machines or mobile work machines (such as mobile robots and mobile automated or autonomous transport vehicles, etc.), for example autonomous mobile robots, also called AMRs. The aim of the invention is to safely recognize the position of these AMRs and to switch over the safety function, for example, in dependence on this position.

Autonomous mobile robots or autonomous mobile vehicles, especially when they are of heavier types, are primarily secured by a safety function of collision avoidance, i.e. the environment is preferably sensed by a safety laser scanner. As soon as an object is present in the environment, the movement of the autonomous vehicle is influenced so that the autonomous vehicle itself prevents the collision. This can result in a temporary stop of the autonomous vehicle.

However, there are situations in which the primary safety function of collision avoidance has to be dispensed with since this would otherwise hinder the automation process. They are in particular situations such as docking and collaboration maneuvers of the autonomous vehicle at stationary machines, passing through constricted points, etc. The primary safety function is then switched off in these situations since it can, however, not be unambiguously determined whether the autonomous vehicle is also at the intended position in this respect, there may be restrictions of the functional safety. The productivity of the autonomous vehicle can furthermore also be greatly reduced since speeds and forces of the drive of the AMR have to be reduced.

The primary safety function of collision avoidance is not switched over with reference to knowledge of the position in accordance with the prior art, but rather with reference to other features.

Static objects are recognized in the field of view of the laser scanner, for example, and the autonomous vehicle is stopped for a brief period. A check is then made by the scanner by means of contour recognition fields whether a deduction can be made with reference to the detected contours whether it is a safe point of interest.

All the approaches known to date have the problem, however, that a safe point of interest cannot be unambiguously identified in the sense of functional safety engineering. These approaches have therefore then always been accompanied by further safety measures; for example, the reduction of the speed and force of the autonomous vehicle that are disadvantageous for the productivity of the automation process.

A functionally safe processing of the localization information is not possible in accordance with the current prior art since technical requirements are currently lacking:
A localization system itself has not yet been functionally safely designed, i.e. the determined positions have to be defined as unsafe in the sense of functional safety.
Measured data of the laser scanners that represent the input data for a LIDAR based localization system cannot currently be defined as safe in the sense of functional safety.
There is not yet any standardized bus/communication protocols of functional safety that make it possible to safety transfer a large amount of measured data.
There is currently not yet any safety controller that is sufficiently powerful to calculate a safe localization based on received safe measured data.

All the current solutions are not yet able to unambiguously recognize a safe point of interest in the sense of functional safety. The system response that is initiated therefore always results in a reduction of safety or in a reduction in productivity in these situations, for example a reduction in the drive power to reduce a speed of an autonomous vehicle.

DE102019128782A1 discloses a movable machine having a safety system, having a safety controller, having a localization system, having a distance sensor for an at least areal monitoring of a monitored zone, and having a contour recognition unit, wherein a position of a safe point of interest can be identified by means of the localization system and a contour of the safe point of interest can be identified by means of the distance sensor and the contour recognition unit, with a change of the safety function of the safety function taking place by means of the safety controller on an identification of the position of the safe point of interest and of the contour of the safe point of interest.

It is an object of the invention to provide an improved redundant safety system for a mobile machine.

The object is satisfied in accordance by a redundant safety system for a mobile machine having at least one controller, having a first localization system for localizing a position of at least one safe point of interest, having a detection system for detecting a feature of the safe point of interest, wherein a position of the safe point of interest can be detected by means of the localization system and a feature of the safe point of interest can be detected by means of the detection system, with a safety zone associated with the safe point of interest being able to be activated by means of the controller on detection of the position of the safe point of interest and of the feature of the safe point of interest.

The object is furthermore satisfied by a method having a redundant safety system for a mobile machine, having at least one controller, having a first localization system for localizing a position of at least one safe point of interest, having a detection system for detecting a feature of the safe point of interest, wherein a position of the safe point of interest is detected by means of the localization system and a feature of the safe point of interest is detected by means of the detection system, with a safety zone associated with the safe point of interest being activated by means of the controller on detection of the position of the safe point of interest and of the feature of the safe point of interest.

The safe point of interest can be synonymously also called a safety position. The safety zone can be synonymously also called a safety area.

The safe point of interest (SPOI) is a simplified variant of a safe positioning that is restricted to a detection of particular positions in an industrial application at which it is for example necessary to adapt the safety system or protective equipment or a safety function of the mobile machine to ensure both personal protection and machine availability.

The intended purpose of the safety system comprises recognizing special hazard points at which the safety function that is generally used to secure the mobile machine is not sufficient because it does not correspond to the demands of an automation function. These points or locations are called safe points of interest (SPOIs) here. All these safe points of interest have to be recognized at a sufficient safety level (e.g. performance level d, PL d) and make it possible for the application to switch to a suitable secondary safety function, for example.

The invention utilizes an existing unsafe localization system to detect the position. An additional feature is then evaluated at the relevant safe points of interest.

The redundant safety system is thereby formed. The redundant safety system is thereby also formed as diverse since respective different features are evaluated, namely the position and the independent feature of the safe point of interest.

A safe zone of interest associated with the safe point of interest can thereupon be activated.

A suitable secondary safety function can then be activated on the system level, for example, corresponding to a hazard demand.

The unsafe localization system can utilize different technologies.

A safe zone of interest or a safe area of interest (SAOI) can then be further safely localized for a limited area based on the safe point of interest determined by means of the safety system. The safe point of interest forms the starting position and the associated position for the safe zone of interest. The safe point of interest here so-to-say represents the entry gate into the safe zone of interest. A safe zone of interest can then, for example, be formed or spanned around the safe point of interest with a radius r, for example (for example 20 m) in which then a safe localization can be carried out over a limited area with the monitored zone via an integration of odometric data, for example.

The safe point of interest function is thus expanded to the safe zone of interest. A predefined zone can be safely detected and monitored by the monitoring of the safe zone of interest. The safe zone of interest defines a maximum size of the zone in which the position information can be considered safety related information that is safe up to the required performance level d. The safe zone of interest is activated by a passing through of a safe point of interest; the safe zone of interest is then active for a maximum radius around the safe point of interest, for example. This radius defines the maximum size if a safe zone of interest, for example, The safety system then, for example, automatically constantly monitors the maximum size of the safe zone of interest using the information from the localization system and optionally from information from a second source, for example odometry. The safe zone of interest is deactivated when the mobile machine departs the maximum permitted size of a safe zone of interest.

Safe zones of interest can overlap. When the mobile machine changes from one safe zone of interest to another safe zone of interest, the previous safe zone of interest is deactivated by the system as soon as the new input safe zone of interest is activated by the system. An activation of a safe zone of interest requires that a valid safe point of interest has been recognized, i.e. if safe zones of interest overlap without gaps, the safe point of interest of the next safe zone of interest has to lie within the radius of the currently active safe zone of interest.

There can be additional safe geo fences (SGFs) within a safe zone of interest. These safe geo fences are activated on the basis of position information (X, Y coordinates) of the safe point of interest when the demand of an active safe zone of interest has been satisfied. Safe geo fences do not need to be subsets of safe zones of interest. Safe geo fences can be formed within different overlapping safe zones of interest.

A switchover between primary and secondary safety functions can take place on the basis of information on the safe position of the safe point of interest. The system can provide different possibilities as to how the information on the safe position can be provided to other functions that can activate the secondary safety function.
as position information consisting of X and Y coordinates
as a safe point of interest and a safe geo fence with associated identifications.

It is ensured, for example, during a start-up/departure process (for example at the speed v=1 m/s) that the mobile machine can stop before a collision. To achieve a proper application behavior in which both productivity and safety are ensured, a secondary safety function, that is the activation of a protected field, and the primary safety function overlap for the duration of the response time. This would be in accordance with a following sequence, for example:

1. Recognizing a safe point of interest
2. Activating a secondary safety function
3. Primary and secondary safety functions are active for at least one cycle of the system response time
4. Deactivating the primary safety function (for example overtaking process)
5. Maintaining the safe point of interest with the safe zone of interest (safe zone of interest with x meters) by a plausibility check between movement (localization and second signal source, e.g. encoder) and contour information, for example
6. Recognizing the departure from the safe point of interest, e.g. by means of measures that ensure that the departure from the safe zone of interest has already been recognized prior to the departure from the safe zone of interest (for example at least one cycle of the system response time)
7. Activating the primary safety function
8. Primary and secondary safety functions are active for at least one cycle of the system response time
9. Deactivating the secondary safety function

The mobile machine can, for example, be a guideless vehicle, a driverless vehicle or autonomous vehicle, an automated guided vehicle (AGV), an autonomous mobile robot (AMR), an industrial mobile robot (IMR), or a robot having movable robot arms. The mobile machine thus has a drive and can be moved in different directions.

In a further development of the invention, at least one distance sensor is provided for an at least areal monitoring of a monitored zone or protected field. The distance sensor delivers distance values in at least two-dimensional space. In so doing, the sensor outputs measured values with distance indications and angle indications. For example, the distance is determined by means of time of flight methods or triangulation methods.

In a further development of the invention, the detection system is an identification system for identifying the safe point of interest, with an identity of the safe point of interest being identifiable by means of the identification system, with a safe zone of interest associated with the safe point of interest being able to be activated on detection of the position of the safe point of interest and on the identification of the safe point of interest.

The invention utilizes an existing unsafe localization system to detect the position. An additional feature for the identification is then arranged at the relevant safe points of interest and is identified by the identification sensor.

The safe point of interest is safely recognized in the sense of functional safety using the two independent features, namely the position and the identification. The redundant safety system is thereby formed. The redundant safety system is thereby also formed as diverse since respective different features are evaluated, namely the position and the identification of the safe point of interest.

The activation of a safe point of interest takes place on the basis of position information and the additional identification of, for example, an identifier at the safe point of interest.

A safe point of interest is defined by two features, namely the position or the location and the identity or identifier in the system environment. These features are independent of and different from one another.

Safe point of interest identification information can be based on different technologies such as optical features (contour of a safe point of interest, remission values of a safe point of interest, etc.), radio labels, or transponders such as RFID transponders or UWB transponders, or, for example, barcodes such as 1D barcodes or 2D barcodes, or a second localization system that has sufficiently diverse information, etc.

A safe point of interest and thus a safe zone of interest is defined by two independent features of a safe point of interest, its position (X, Y coordinates) and an identification, identifier, or characterization signature (e.g. an RFID code). This information is stored, for example, as verified information in a map or in a different kind of file. The position and the identification signature with their correlations are stored as a dataset in this file. This information is available to the safety system as configuration information.

Recognizing a safe point of interest can be triggered by the identification system or by the identification unit that is based on an identifier sensor. As soon as one of the two units (localization system or identification system) recognizes a safe point of interest, a safe point of interest recognition tolerance range becomes active, for example, i.e. the second channel (localization system or identification system) likewise has to recognize the safe point of interest within this tolerance, for example. The safe zone of interest is activated as soon as both channels (localization system or identification system) recognize the safe point of interest. In a further development of the invention, the monitoring of the safe zone of interest takes place by means of position data of the first localization system by means of the controller, with a change of a relative position being able to be evaluated by the controller, with the relative position additionally being detected by means of a movement monitoring system.

The movement monitoring system is formed, for example, by an encoder, a drive, or an odometer. The data of the movement monitoring system are used to plausibilize the data of the localization.

In a further development of the invention, the detection system is a second localization system for localizing at least the safe point of interest, with a position of the safe point of interest being detectable by means of the first localization system and the second localization system, with the first localization system and the second localization system having different sensor principles or diverse information sources, and with a safe zone of interest associated with the safe point of interest being able to be activated on detection of the position of the safe point of interest by the first localization system and a detection of the position of the safe point of interest by the second localization system.

As soon as a safe point of interest has been recognized, safe zones of interest are activated around this safe point of interest. Starting from the recognized safe point of interest, the safe zone of interest is defined as a relative position difference in the X and Y directions about the safe point of interest. The relative position difference is incremented from the safe point of interest onward. This incrementation of the relative position takes place on the basis of the information of the first localization system and of a movement detection system (for example an encoder/drive, odometer, etc.) or of the second localization system (radio location, etc.). The relative position incrementation between the first localization system and the movement detection system or the second localization system is constantly checked. If the pieces of information do not agree, the safety controller switches into the safe state.

In a further development of the invention, the safe zone of interest can be activated with a predefined shape.

The predefined shape can be a circular shape, an elliptical shape, a pitch circular shape, a semicircular shape, a rectangular shape, a quadratic shape, or also a freeform shape. Geometrical shapes can be mapped in an algorithmically simplified form. The shape here is dependent on the application case. A freeform shape as a predefined shape provides the user with high flexibility in a specific application.

In a further development of the invention, the position of the safe point of interest is provided in the controller for further processing as a safety related position within the safe zone of interest. The safety related position is stored, for example, by means of checksums so that the data of the safety related position are failsafe.

In a further development of the invention, the position of the safe point of interest is provided for external components as a safety related position within the safe zone of interest by means of a communications network, for example by means of Ethernet. The safety related position is saved, for example, by means of checksums so that the data of the safety related position can be transferred by means of a communications network in a failsafe manner.

In a further development of the invention, the position of the safe point of interest is provided for external components as discrete identifiers, for example numerals associated with the location, by means of Ethernet. The position of the safe point of interest can be more easily identified and associated by the identifiers.

In a further development of the invention, the safe zone of interest can be divided into safe geo fences. There can be additional safe geo fences (SGFs) within a safe zone of interest. These safe geo fences are activated on the basis of position information (X, Y coordinates) of the safe point of interest when the demand of an active safe zone of interest has been satisfied. Safe geo fences do not need to be subsets of safe zones of interest. Safe geo fences can be formed within different overlapping safe zones of interest.

In a further development of the invention, the safe geo fences can be activated with a predefined shape. The predefined shape can be a circular shape, an elliptical shape, a pitch circular shape, a semicircular shape, a rectangular shape, a quadratic shape, or also a freeform shape. Geometrical shapes can be mapped in an algorithmically simplified form. The shape here is dependent on the application case. A freeform shape as a predefined shape provides the user with high flexibility in a specific application.

In a further development of the invention, the safe geo fences are provided for external components as discrete identifiers, for example numerals associated with the location, by means of Ethernet The safe geo fences can be identified and associated more easily by the identifiers.

In a further development of the invention, the redundant safety system has at least two controllers.

The calculation of the safe point of interest and the safe zone of interest takes place on two controllers, for example on two industrial personal computers (IPCs). They mutually monitor themselves in their performance. The safe performance of the safety functions of safe point of interest and safe zone of interest can also be implement without an explicit safety controller by the mutual monitoring. The mutual monitoring includes different mechanisms, for example.

Since the further development is carried out on an industrial personal computer and not on a safety controller, more complex data can be processed and the integration into more complex automation systems is simpler.

It is primarily placed on top of existing hardware so that only a little effort is required for particular hardware.

A safe point of interest recognition algorithm runs in two different implementations, for example, both on the first industrial PC and on the second industrial PC. The algorithm has access to the information of the localization system and to the identification system on both industrial PCs. The algorithm has corresponding rules on both industrial PCs between the position in X, Y coordinates, theta, and the corresponding identifier read by the identification system.

In a further development of the invention, at least a mutual monitoring of the two controllers (industrial PCs) is provided. It is here in particular a mutual watchdog monitoring or check unit monitoring. One respective controller provides the watchdog or the check unit for the respective other controller. The controllers mutually monitor one another with a clear time specification. The IPCs restart a timer or counter of a check unit after every communication/data exchange cycle. The next data exchange has to be carried out before the timer or counter of the check unit runs out. If the timer or counter runs out, the system switches into the safe state. Time stamps of generated data can additionally be checked.

In a further development of the invention, a software code performance check unit is provided in the controller. A check of the workthrough sequence of the code performance of the controllers takes place by the software code performance check unit. If the workthrough sequence does not agree with an expectation, an error is present and a warning is output or the mobile machine is slowed down or stopped.

In a further development of the invention, a redundant performance of used algorithms takes place by the controllers. I.e. used algorithms are executed independently of one another in the two controllers.

In a further development of the invention, a plausibilization of sensor data takes place by the controllers. The speed information from a second source, e.g. from encoders, is, for example, available on the first controller and is also transmitted to the second controller via an interface between the controllers. The speed information from this second source is used to check whether the orientation of the mobile machine has changed, for example. The speed information from two encoders at an axle of which one is attached to the right wheel and the other to the left wheel is thus compared, for example. As soon as there is a speed difference, the mobile machine will travel a curve. This can be a trigger for the activation of this check. As a response to this, an orientation angle of the localization system has to change in the same direction by an amount that is measured by the information of the second source. The information of the second source and the information of the localization system are compared with one another and checked.

In a further development of the invention, a plausibilization of the data of the localization system takes place with data of a movement monitoring system, an odometer, or an odometric device in the controller. The monitoring of the safe zone of interest takes place by means of position data of the first localization system by means of the controller, with a change of a relative position being able to be evaluated by the controller, with the relative position additionally being detected by means of a movement monitoring system. The movement monitoring system is formed, for example, by an encoder, a drive, or an odometer. The data of the movement monitoring system are used to plausibilize the data of the localization.

In a further development of the invention, the controllers are formed as electronically diverse. A use of diverse hardware is in particular advantageous in the controllers, in particular industrial PCs, since systematic errors, caused by the electronics or by the processors, can hereby be avoided or reduced. The two controllers have different processors from different manufacturers, of different types or of different architectures, for example.

In a further development of the invention, the controllers are formed as diverse in the software. A use of, for example, diverse software frameworks is in particular advantageous in the controllers, in particular industrial PCs, since systematic errors, caused by the software that is executed, can hereby avoided or reduced.

The two controllers have different software or firmware from different manufacturers, of different codings, of different programming languages, or of different architectures, for example.

In a further development of the invention, the distance sensor is a laser scanner, a safety laser scanner, a 3D camera, a stereo camera, or a time of flight camera.

To avoid collisions and to protect persons, the laser scanner or the safety laser scanner, for example, monitors a protected field that may not be entered by persons during the movement of the mobile machine. If the laser scanner recognizes an unauthorized intrusion into the protected field, for instance a leg of a person, the laser scanner triggers an emergency stop of the mobile machine.

Sensors used in safety engineering have to intrinsically work particularly reliably inherently safely and must therefore satisfy high safety demands, for example the standard EN13849 for safety of machinery and the machinery standard EN61496 for electrosensitive protective equipment (ESPE).

To satisfy these safety standards, a series of measures have to be taken such as a secure electronic evaluation by redundant and/or diverse electronics or different functional monitoring processes, especially the monitoring of the contamination of optical components, including a front screen. A safety laser scanner in accordance with such standards is known, for example, from DE 43 40 756 A1.

The term “functionally safe” is to be understood in the sense of the standards named or of comparable standards; measures are therefore taken to control errors up to a specified safety level. The safe sensor and/or at least one non-safe sensor moreover generates/generate unsafe data such as raw data, point clouds, or the like. Unsafe is the opposite of safe for unsafe devices, transmission paths, evaluations, and the like and accordingly said demands on failsafeness are not satisfied.

A 3D camera, for example, likewise monitors a monitored zone of the mobile machine by means of a plurality of detected distance values. A 3D camera has the advantage that a volume-type protected zone can be monitored.

A stereo camera, for example, likewise monitors a monitored zone of the mobile machine by means of a plurality of detected distance values. The distance values are determined on the basis of the two camera of the stereo camera that are installed at a basic spacing from one another. A stereo camera equally has the advantage that a volume-type protected zone can be monitored.

Distance values on the basis of the measured time of flight that are determined by an image sensor are determined by means of a time of flight camera. A time of flight camera equally has the advantage that a volume-type protected zone can be monitored.

In a further development of the invention, the localization system is a radio location system or an optoelectronic location system.

The position data can be based on different technologies, e.g. radio technology in accordance with the 5G standard, UWB radio location, or, for example, LIDAR localization on the basis of the time of flight.

The recognition of a safe point of interest takes place by diversity of the features of a safe point of interest. Diversity can be achieved by the use of different localization technologies (e.g. 5G in combination with LIDAR localization) or by the combination of localization technologies and an identifier of a safe point of interest (e.g. LIDAR localization in combination with RFID).

The localization system can determine a position of the mobile machine on a surface or in space. The position determination can, for example, take place locally by means of radio, for example by an ultra-wideband system (UWB). A LIDAR navigation can furthermore be provided for position determination. Global navigation systems can also be used such as a GPS system.

The optoelectronic localization system for the at least areal monitoring of a monitored zone is a sensor for distance measurement. The distance sensor delivers distance values in at least two-dimensional space. In so doing, the sensor outputs measured values with distance indications and angle indications. For example, the distance is determined by means of time of flight methods or triangulation methods.

In a further development of the invention, the identification system is a radio identification system, an optical identification system, or a second localization system that has sufficiently diverse information.

Safe points of interest identification information can be based on different technologies such as optical features (contour of a safe point of interest, remission values of a safe point of interest, etc.), radio labels or transponders such as RFID transponders or UWB transponders, or barcodes such as 1D barcodes or 2D barcodes, etc.

In a further development of the invention, the localization system has a map or a map model, with safe points of interest being entered in the map or map model.

In particular LIDAR based localization systems that work on map data are suitable here. The maps are based on contour data that have been determined by the scanners in a measurement pass.

The different positions of the safe points of interest are entered in the map model or in an electronic map. The current position and/or location of the mobile machine is/are continuously processed in the localization system on the basis of detected environmental contours and is/are checked for agreement with a safe point of interest. If an agreement is found, in accordance with a further development of the invention, a position identifier of the safe point of interest is transmitted to the controller.

In a further development of the invention, the position and the identity of a safe point of interest are linked via a correlation rule.

A correlation rule, for example a table, a software code, or similar, is stored in the software of the controllers (industrial PCs) and an association between the position and the identity of a safe point of interest is linked therein. The position and the identity of a safe point of interest are checked in a cross-comparison, for example.

If both part systems deliver consistent identifiers that can be associated with one another, a safe point of interest has been recognized and the controller can activate the safe zone of interest. The controller can furthermore switch to a different protective measure or safety function. The switching over of the protective measure can comprise, for example, a switching over of protected fields, a size or shape matching of protected fields, and/or a switching over of the properties of a protected field. The properties of a protected field include, for example, the resolution and/or the response time of the protected field. A switching over of the protective measure can also be a safety function such as a force restriction of the drive to which the switchover is made.

If the position and the identity of a safe point of interest do not agree, the safe point of interest recognizes an error and changes into the safe state, i.e. the safety system outputs an internal status range of the software and, a LOW signal to digital outputs.

The invention will also be explained in the following with respect to further advantages and features with reference to the enclosed drawing and to embodiments. The Figures of the drawing show in:

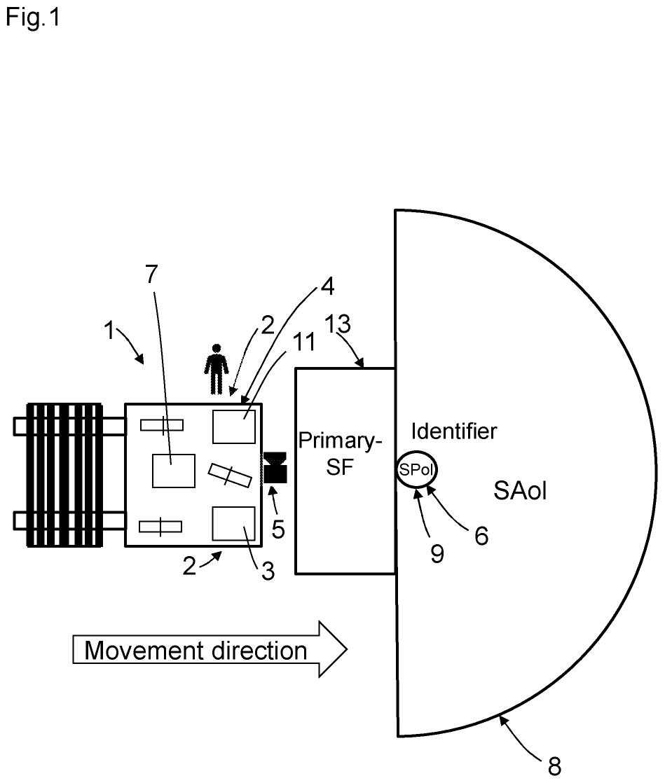

FIG. 1 a mobile machine having a redundant safety system;

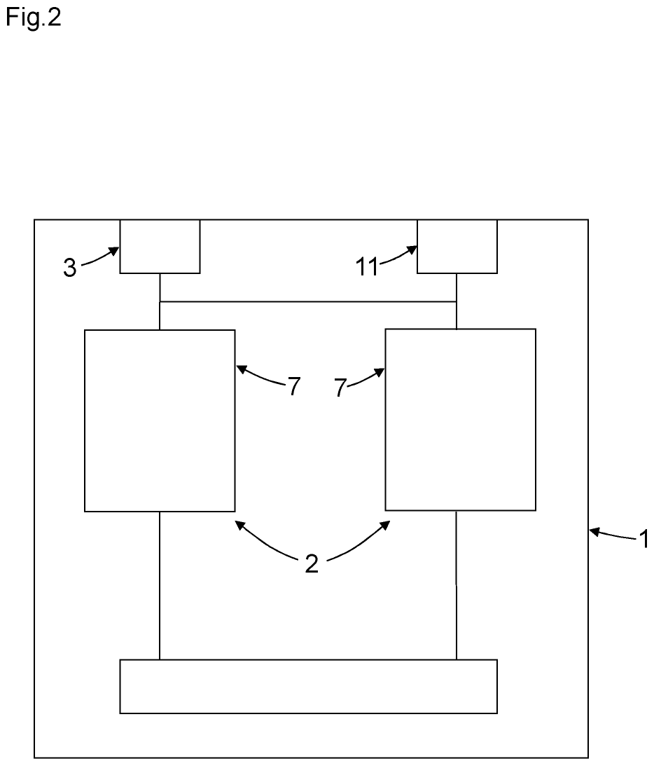

FIG. 2 a redundant safety system;

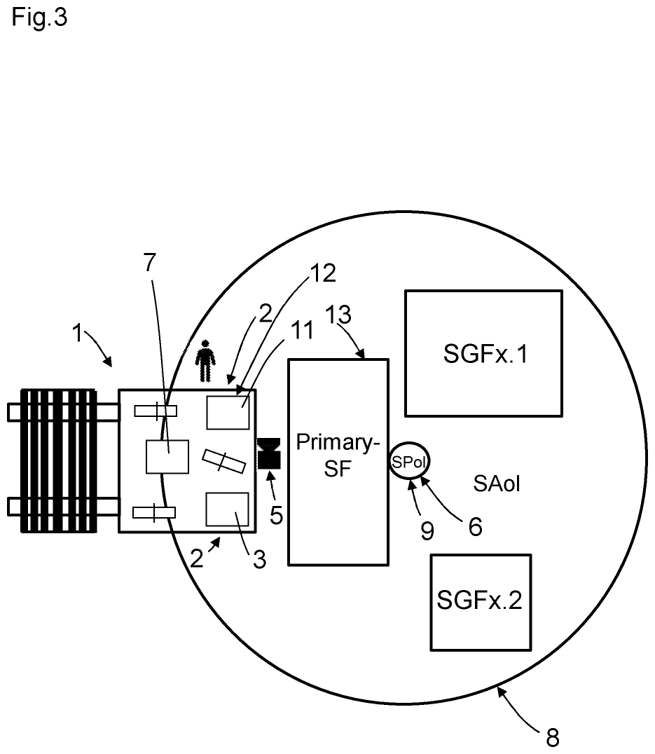

FIG. 3 a mobile machine at a safe point of interest with a safe zone of interest;

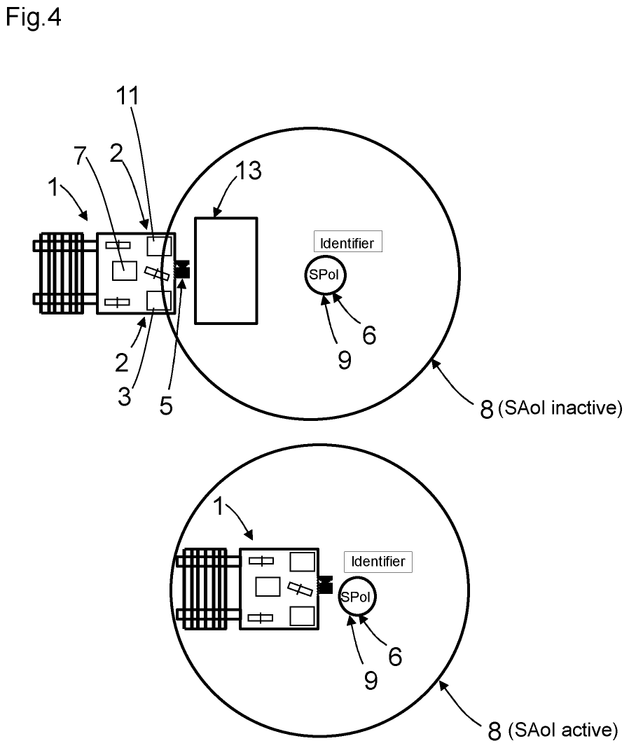

FIG. 4 a mobile machine at a safe point of interest with a safe zone of interest;

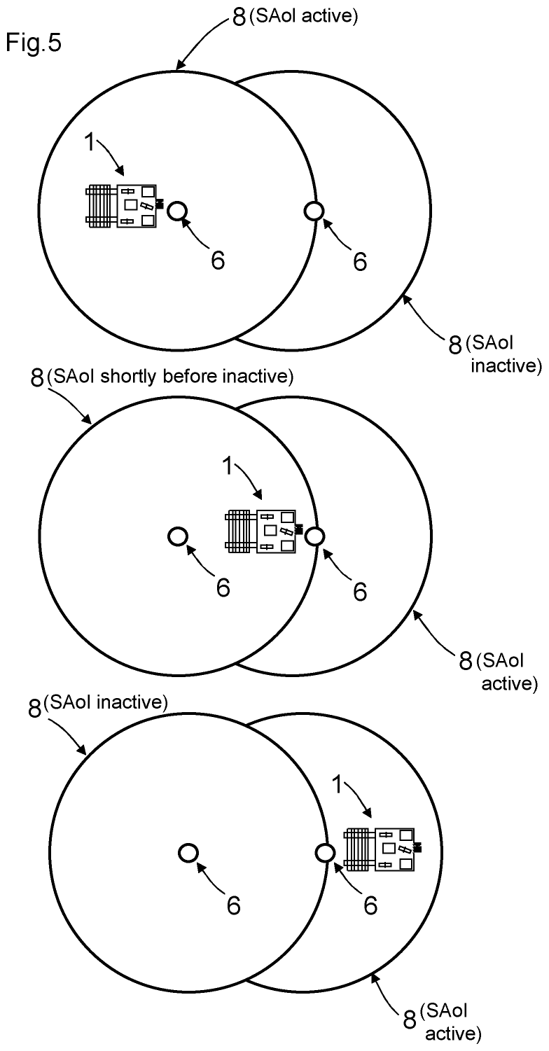

FIG. 5 a respective mobile machine and overlapping safe zones of interest;

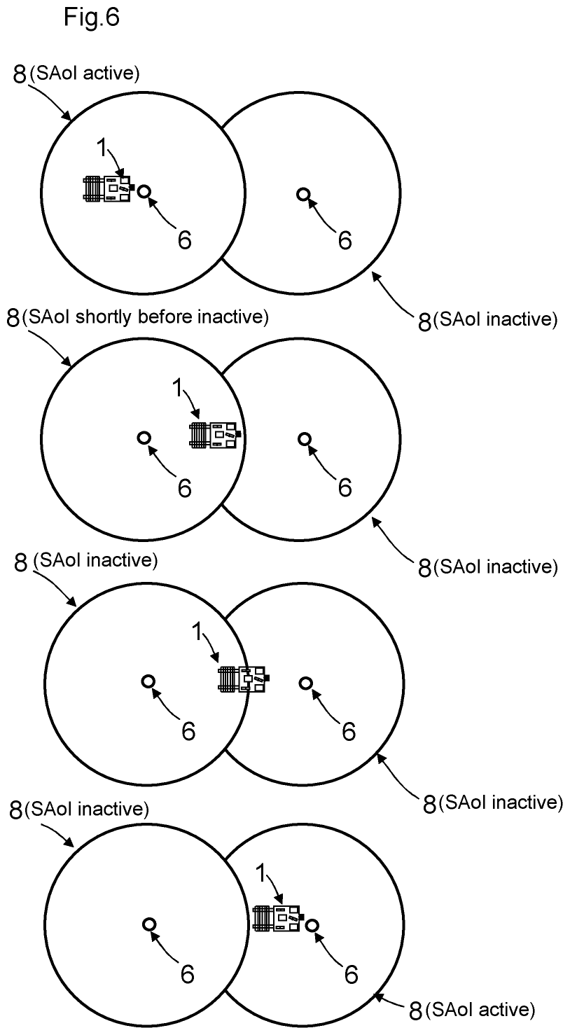

FIG. 6 a respective mobile machine and non-overlapping safe zones of interest; and

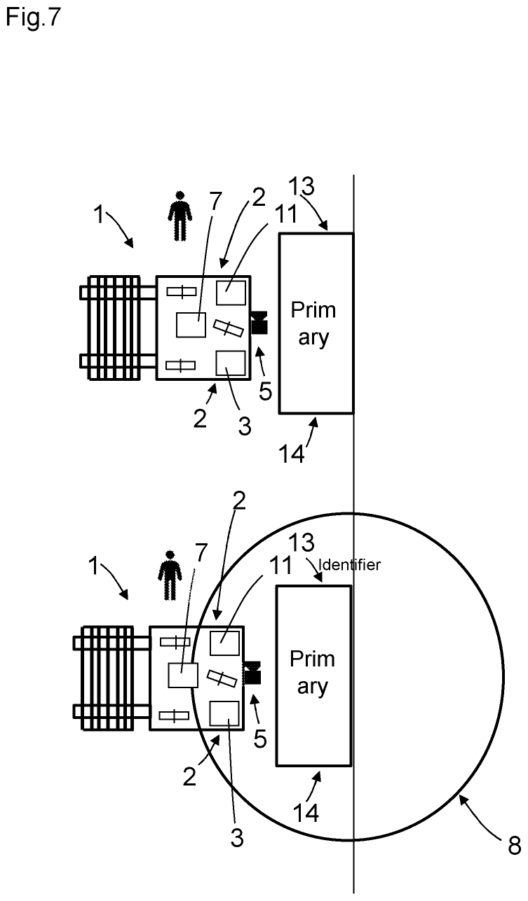

FIG. 7 a respective mobile machine in a movement routine with a safe zone of interest.

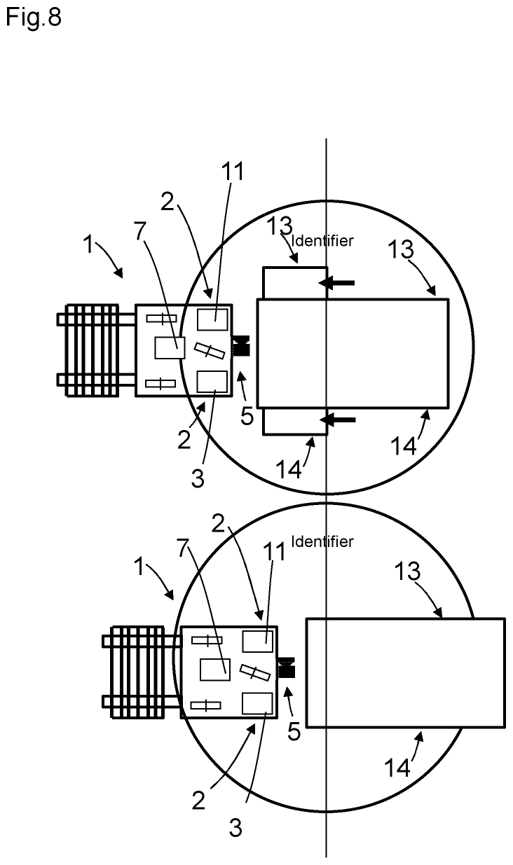

FIG. 8 a respective mobile machine in a movement routine with a safe zone of interest.

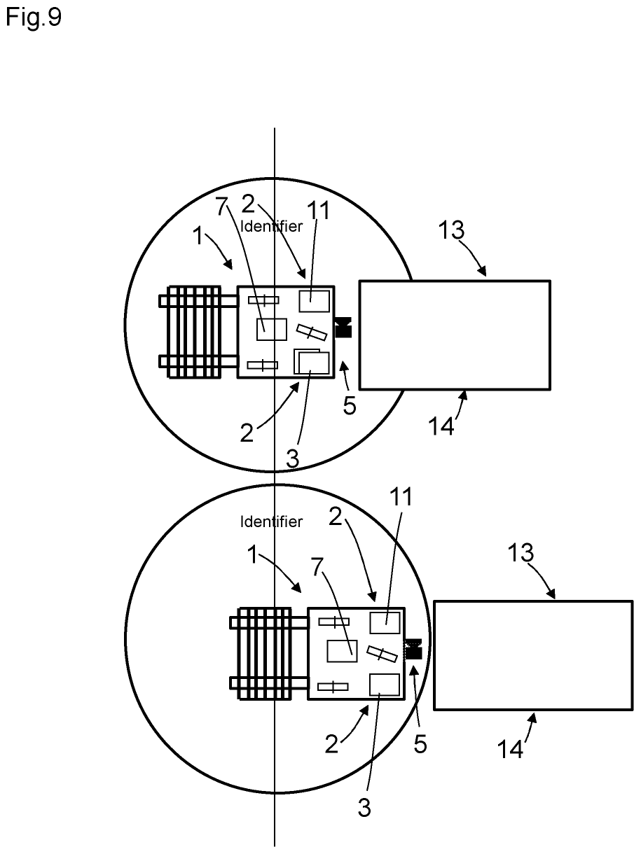

FIG. 9 a respective mobile machine in a movement routine with a safe zone of interest.

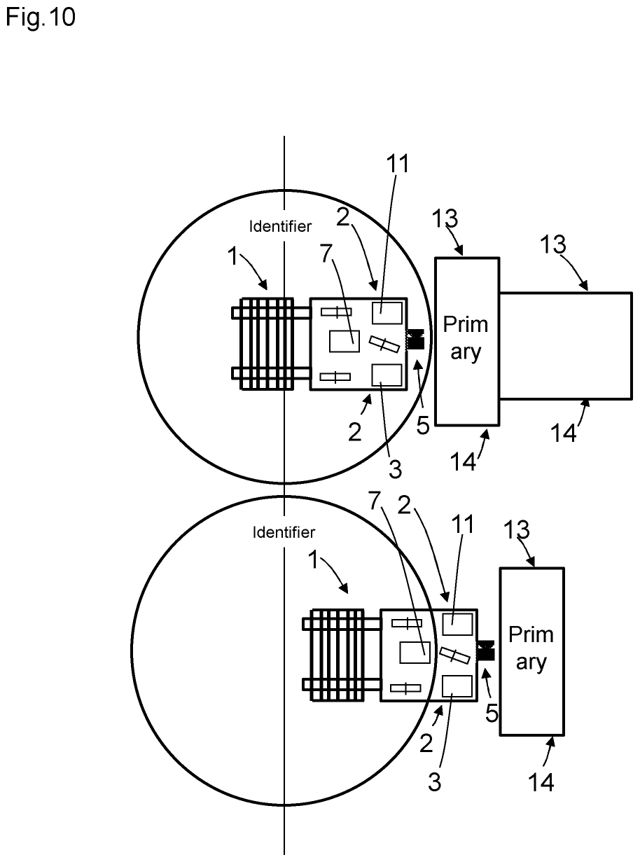

FIG. 10 a respective mobile machine in a movement routine with a safe zone of interest.

In the following Figures, identical parts are provided with identical reference numerals.

FIG. 1 shows a redundant safety system 2 for a mobile machine 1 having at least one controller 7, having a first localization system 3 for localizing a position of at least one safe point of interest 6, having a detection system 11 for detecting a feature of the safe point of interest 6, wherein a position of the safe point of interest 6 can be detected by means of the localization system 3 and a feature of the safe point of interest 6 can be detected by means of the detection system 11, with a safe zone of interest 8 associated with the safe point of interest 6 being able to be activated on detection of the position of the safe point of interest 6 and of the feature of the safe point of interest 6.

Optionally, at least one distance sensor 5 is provided for an at least areal monitoring of a monitored zone 13.

The distance sensor 5 for the at least areal monitoring of a monitored zone 13 is a sensor for distance measurement. The distance sensor 5 delivers distance values in at least two-dimensional space. In so doing, the distance sensor 5 outputs measured values with distance indications and angle indications. For example, the distance is determined by means of time of flight methods or triangulation methods.

The distance sensor 5 is for example a laser scanner, a safety laser scanner, a 3D camera, a stereo camera, or a time of flight camera.

The mobile machine can, for example, be an automated guided vehicle, a driverless vehicle, or an autonomous vehicle, etc.

The safe point of interest 6 is a simplified variant of a safe positioning that is restricted to a detection of particular positions in an industrial application at which it is, for example, necessary to adapt the safety system 2, or protective equipment, or a safety function of the mobile machine 1 to ensure both personal protection and machine availability.

The intended purpose of the safety system 2 comprises recognizing special hazard points at which the safety function that is generally used to secure the mobile machine 1 is not sufficient because it does not correspond to the demands of an automation function. These points or locations are called safe points of interest 6 here. All these safe points of interest 6 have to be recognized at a sufficient safety level (e.g. performance level d, PL d) and make it possible for the application to switch to a suitable secondary safety function, for example.

A safe zone of interest 8 associated with the safe point of interest 6 can thereupon be activated. Optionally, at least one distance sensor 5 is provided for an at least areal monitoring of a monitored zone 13.

A suitable secondary safety function can then be activated on the system level, for example, corresponding to a hazard demand, as is shown in FIG. 8.

Based on the safe point of interest 6 determined by means of the safety system 2, localization can then be safely continued within the framework of the safe zones of interest or a safe area of interest for a limited area and the monitored zone can be monitored by the distance sensor 5. The safe point of interest 6 forms the starting position and the associated position for the safe zone of interest 8. The safe point of interest 6 here so-to-say represents the entry gate into the safe zone of interest 8. A safe zone of interest 8 can, for example, be formed or spanned in accordance with FIG. 3 around the safe point of interest 6 with a radius r, for example (for example 20 m) in which then a safe localization can be carried out over a limited area via an integration of odometric data, for example.

The safe point of interest function is thus expanded to the safe zone of interest 8. A predefined zone can be safely detected and monitored by the monitoring of the safe zone of interest 8. The safe zone of interest 8 defines a maximum size of the zone in which the position information can be considered safety related information that is safe up to the required performance level d. The safe zone of interest 8 is activated by a passing through of a safe point of interest 6; the safe zone of interest 8 is then active for a maximum radius around the safe point of interest 6, for example. This radius defines the maximum size of a safe zone of interest 8, for example, The safe zone of interest 8 is deactivated when the mobile machine 1 departs the maximum permitted size of a safe zone of interest 8.

Safe zones of interest 8 can overlap in accordance with FIG. 5. When the mobile machine changes from one safe zone of interest 8 to another safe zone of interest 8, the previous safe zone of interest 8 is deactivated by the system as soon as the new input safe zone of interest 8 is activated by the system. An activation of a safe zone of interest 8 requires that a valid safe point of interest 6 has been recognized, i.e. if safe zones of interest 8 overlap without gaps, the safe point of interest 6 of the next safe zone of interest 8 has to lie within the radius of the currently active safe zone of interest 8.

However in accordance with FIG. 6, there can also be no overlap between the safe zones of interest 8.

There can be additional safe geo fences (SGFs) within a safe zone of interest 8. These safe geo fences are activated on the basis of position information (X, Y coordinates) of the safe point of interest 6 when the demand of an active safe zone of interest 8 has been satisfied. Safe geo fences do not need to be subsets of safe zones of interest 8. Safe geo fences can be formed within different overlapping safe zones of interest 8.

A switchover between primary and secondary safety functions in accordance with FIG. 8 can take place on the basis of information on the safe position of the safe point of interest. The system can provide different possibilities as to how the information on the safe position can be provided to other functions that can activate the secondary safety function.
as position information consisting of X and Y coordinates
as a safe point of interest and a safe geo fence with associated identifications.

In accordance with FIGS. 7 to 10, it is ensured, for example, during a start-up/departure process (for example at the speed v=1 m/s) that the mobile machine 1 can stop before a collision. To achieve a proper application behavior in which both productivity and safety are ensured, a secondary safety function, that is the activation of the protected field 14, and the primary safety function overlap for the duration of the response time. This would be in accordance with a following sequence, for example:
1. Recognizing a safe point of interest 6
2. Activating a secondary safety function
3. Primary and secondary safety functions are active for at least one cycle of the system response time
4. Deactivating the primary safety function (for example overtaking process)
5. Maintaining the safe point of interest 6 with the safe zone of interest (safe zone of interest with x meters) by a plausibility check between movement (localization and second signal source, e.g. encoder) and contour information, for example
6. Recognizing the departure from the safe point of interest 6, e.g. by means of measures that ensure that the departure from the safe zone of interest 8 has already been recognized prior to the departure of the safe zone of interest 8 (for example at least one cycle of the system response time)
7. Activating the primary safety function
8. Primary and secondary safety functions are active for at least one cycle of the system response time
9. Deactivating the secondary safety function.

For example in accordance with FIG. 1, the detection system 11 is an identification system 4 for identifying the safe point of interest 6, with an identity of the safe point of interest 6 being identifiable by means of the identification system 4, with a safe zone of interest 8 associated with the safe point of interest 6 being able to be activated on detection of the position of the safe point of interest 6 and on the identification of the safe point of interest 6.

An unsafe localization system is used, for example, to detect the position. An additional feature for the identification is then arranged at the relevant safe points of interest 6 and is identified by the identification sensor.

The safe point of interest 6 is safely recognized in the sensor of functional safety using the two independent features, namely the position and the identification. The redundant safety system 2 is thereby formed. The redundant safety system 2 is thereby also formed as diverse since respective different features are evaluated, namely the position and the identification of the safe point of interest 6.

The activation of a safe point of interest 6 takes place on the basis of position information and the additional identification of, for example, an identifier at the safe point of interest 6.

A safe point of interest 6 is defined by two features, namely the position or the location and the identity or identifier, in the system environment. These features are independent of and different from one another.

Safe points of interest identification information can be based on different technologies such as optical features (contour of a safe point of interest, remission values of a safe point of interest, etc.), radio labels, or transponders such as RFID transponders or UWB transponders, or barcodes such as 1D barcodes or 2D barcodes, a second localization system that has sufficiently diverse information, etc.

A safe point of interest 6 and thus a safe zone of interest 8 is 6 defined by two independent features of a safe point of interest 6, its position (X, Y coordinates) and an identification, identifier, or characterization signature (e.g. an RFID code). This information is stored, for example, as verified information in a map or in a different kind of file. The position and the identification signature with their correlations are stored as a dataset in this file. This information is available to the safety system as configuration information.

Recognizing a safe point of interest 6 can be triggered by the identification system 4 or by the identification unit that is based on an identifier sensor. As soon as one of the two units (localization system 3 or identification system 4) recognizes a safe point of interest 6, a safe point of interest recognition tolerance range becomes active, for example, i.e. the second channel (localization system or identification system) likewise has to recognize the safe point of interest 6 within this tolerance, for example. The safe zone of interest 8 is activated as soon as both channels (localization system or identification system) recognize the safe point of interest 6.

In accordance with FIG. 3, for example, the detection system 11 is a second localization system 12 for localizing at least the safe point of interest 6, with a position of the safe point of interest 6 being detectable by means of the first localization system 3 and the second localization system 12, with the first localization system 3 and the second localization system 12 having different sensor principles, and with a safe zone of interest 8 associated with the safe point of interest 6 being able to be activated on detection of the position of the safe point of interest 6 by the first localization system 3 and a detection of the position of the safe point of interest by the second localization system 12.

The distance sensor 5 can here also form part of the first localization system 3 or the second localization system 12.

The safe zone of interest 8 can, for example, be activated with a predefined shape.

The predefined shape can be a circular shape accordance with FIG. 3, an elliptical shape, a pitch circular shape accordance with FIG. 1, a semicircular shape accordance with FIG. 1, a rectangular shape, a quadratic shape, or also a freeform shape.

In accordance with FIG. 2, the redundant safety system 2 has at least two controllers 7.

The calculation of the safe point of interest 6 and the safe zone of interest 8 takes place on two controllers 7, for example on two industrial personal computers (IPCs). They mutually monitor themselves in their performance. The safe performance of the safety functions of safe point of interest 6 and safe zone of interest 8 can also be implemented without an explicit safety controller by the mutual monitoring. The mutual monitoring includes different mechanisms, for example. for error recognition or for error diagnosis.

A safe point of interest recognition algorithm runs in two different implementations, for example, both on the first industrial PC and on the second industrial PC. The algorithm has access to the information of the localization system 3 and to the identification system 4 on both industrial PCs. The algorithm has corresponding rules on both industrial PCs between the position in X, Y coordinates, theta, and the corresponding identifier read by the identification system 4.

The localization system 3 or 12 is, for example, a radio location system or an optoelectronic location system.

The identification system 4 is, for example, a radio identification system or an optical identification system.

### REFERENCE NUMERALS

1 mobile machine
2 redundant safety system
3 first localization system
4 identification system
5 distance sensor
6 safe point of interest
7 controller
8 safe zone of interest
9 position
11 detection system
12 second localization system
13 monitored zone
14 protected field

1. A redundant safety system for a mobile machine, the redundant safety system comprising at least one controller;
a first localization system for localizing a position of at least one safe point of interest;
a detection system for detecting a feature of the safe point of interest, wherein a position of the safe point of interest is detectable by means of the localization system;
and a feature of the safe point of interest is detectable by means of the localization system, and wherein a safe zone of interest associated with the safe point of interest can be activated by means of the controller on detection of the position of the safe point of interest.

2. The redundant safety system in accordance with claim 1, wherein at least one distance sensor for an at least areal monitoring of a monitored zone is provided.

3. The redundant system in accordance with claim 1, wherein the detection system is an identification system for identifying the safe point of interest, wherein an identity of the safe point of interest is identifiable by means of the identification system;
wherein a safe zone of interest associated with the safe point of interest can be activated on detection of the position of the safe point of interest and on the identification of the safe point of interest.

4. The redundant safety system in accordance with claim 1, wherein the monitoring of the safe zone of interest takes place by means of position data of the first localization system by means of the controller, with a change of a relative position being able to be evaluated by the controller, with the relative position additionally being detected by means of a movement monitoring system.

5. The redundant safety system in accordance with claim 1, wherein the detection system is a second localization system for localizing at least the safe point of interest,
wherein a position of the safe point of interest is detectable by means of the first localization system and a second localization system;
wherein the first localization system and the second localization system have different sensor principles or diverse information sources;
wherein a safe zone of interest associated with the safe point of interest can be activated on detection of the position of the safe point of interest by the first localization system and on detection of the position of the safe point of interest by the second localization system.

6. The redundant safety system in accordance with claim 1, wherein the safe zone of interest can be activated with a predefined shape.

7. The redundant safety system in accordance with claim 1, wherein the position of the safe point of interest is provided as a safety related position within the safe zone of interest in the controller for further processing.

8. The redundant safety system in accordance with claim 1, wherein the position of the safe point of interest is provided as a safety related position within the safe zone of interest by means of a communications network for external components.

9. The redundant safety system in accordance with claim 1, wherein the position of the safe point of interest is provided as discrete identifiers by means of a communications network for external components.

10. The redundant safety system in accordance with claim 1, wherein the safe zone of interest can be divided into safe geo fences.

11. The redundant safety system in accordance with claim 10, wherein the safe geo fences can be activated with a predefined shape.

12. The redundant safety system in accordance with claim 11, wherein the safe geo fences are provided as discrete identifiers by means of a communications network for external components.

13. The redundant safety system in accordance with claim 1, wherein the redundant safety system has at least two controllers.

14. The redundant safety system in accordance with claim 13, wherein at least a mutual monitoring of the two controllers is provided.

15. The redundant safety system in accordance with claim 13, wherein a software code performance check unit is provided in the controller.

16. The redundant safety system in accordance with claim 13, wherein a redundant performance of used algorithms takes place by the controllers.

17. The redundant safety system in accordance with claim 13, wherein a plausibilization of sensor data takes place by the controllers.

18. The redundant safety system in accordance with claim 13, wherein a plausibilization of the data of the localization system takes place using data of a movement monitoring system, an odometer, or an odometer device in the controller.

19. The redundant safety system in accordance with claim 13, wherein the controllers are electronically diverse.

20. The redundant safety system in accordance with claim 13, wherein the controllers in the software are diverse.

21. The redundant system in accordance with claim 1, wherein the distance sensor is a laser scanner, a safety laser scanner, a 3D camera, a stereo camera, or a time of flight camera.

22. The redundant safety system in accordance with preceding claim 1, wherein the localization system is a radio location system sensor or an optoelectronic localization system.

23. The redundant safety system in accordance with claim 1, wherein the identification system is a radio identification system or an optical identification system.

24. The redundant safety system in accordance with claim 1, wherein the localization system has a map or a map model, with the safe points of interest being entered in the map or in the map model.

25. The redundant safety system in accordance with claim 1, wherein the position and the identity of a safe point of interest are linked via a correlation rule.

26. A method using a redundant safety system for a mobile machine, the redundant safety system comprising at least one controller; a first localization system for localizing a position of at least one safe point of interest; a detection system for detecting a feature of the safe point of interest, wherein a position of the safe point of interest is detected by means of the localization system; and a feature of the safe point of interest is detected by means of the localization system;
the method comprising the step of:
activating a safe zone of interest associated with the safe point of interest by means of the controller on detection of the position of the safe point of interest and of the feature of the safe point of interest.
